(19) United States
(12) Patent Application Publication
(10) Pub. No.: US 2026/0220590 A1
(43) Pub. Date: Jul. 30, 2026

(54) LOGISTICS SYSTEMS AND METHODS FOR OPTIMIZING DELIVERY ROUTES

(71) Applicant: HITACHI, Ltd., Tokyo (JP)

(72) Inventors: Nam HUYN, Milpitas, CA (US); Amit KUMAR, San Jose, CA (US)

(21) Appl. No.: 19/039,722

(22) Filed: Jan. 28, 2025

(51) Int. Cl. G06Q 10/0835; G06Q 10/047

(52) U.S. Cl. CPC G06Q 10/08355; G06Q 10/047

(57) ABSTRACT

Heuristic-search-based systems and methods for optimizing delivery routes in large-scale logistics operations, such in electrical vehicle battery reverse logistics are described. The complex NP-hard problem of minimizing transportation cost, which is affected by both travel distance and payload weight, is solved by leveraging an advanced cost function that considers toll costs and iteratively expanding nodes in a search graph. This strategic approach ensures that all collection locations are visited exactly once, ultimately finding the optimal route that minimizes transportation cost.

### BACKGROUND

### Field

The present disclosure is generally directed to logistics systems, and more specifically, to logistics systems and methods for optimizing delivery routes.

### Related Art

When electric vehicle (EV) batteries reach their end-of-life, they are returned to various locations, such as car dealerships, repair shops, auto dismantlers that oftentimes are geographically widely distributed. For safe handling purposes, the batteries typically need to be moved to and disposed of at a centralized facility, such as a recycling facility. As transportation costs dominate EV battery reverse logistics, minimizing the cost of collecting batteries becomes an important goal, especially when managing reverse logistics at scale. To reduce collection costs, a single truck is dispatched to pick up batteries from numerous collection locations. When considering various cost models, transportation costs stand out as a function of distance travelled. Since EV batteries are heavy objects, oftentimes averaging more than 1000 lbs. each, weights play a significant role in transportation costs. For a given set of locations at which batteries are collected, the transportation cost largely depends on the route taken, and the optimal route varies depending on whether the payload weights are considered in the cost calculations.

Accordingly, it is desirable to have reverse logistics systems and methods that optimize delivery routes and, thus, operational costs.

### SUMMARY

In some aspects of the disclosure, a method for optimizing delivery routes to reduce transportation cost comprises: defining a cost function comprising a toll cost, which, as defined with reference to Eq. (1) below, is a weight-dependent cost associated with both travel distance and payload weight; in response to receiving a starting location, a set of collection locations that each is associated with a payload weight and to be visited exactly once, and a set of final destinations, selecting an initial node comprising the starting location, which represents a state where no collection locations have been visited to initialize a search graph in which each node represents a state in a search space; in response to expanding the initial node by generating child nodes that each represents a visit to an unvisited collection location, updating the state; using the cost function to calculate, for each child node, a cost for the path between the initial node and the child node; selecting, among all nodes that have not been expanded, a node associated with a lowest estimated total cost, for node expansion; iterating expansion and cost computation steps until all collection locations in the set of collection locations have been visited; expanding nodes that have visited all collection locations by generating child nodes representing the set of final destinations; in response to a node selected for expansion being a goal node, using the goal node to define an optimal route from the starting location to a final destination, such that the optimal route visits all collection points exactly once; and using the optimal route to minimize the transportation cost.

In some aspects, information represented in a state in the search space comprises a current path, cumulative weight, and path cost.

Some aspects further comprise the step of adjusting the cost function to comprise toll costs based on a vehicle weight; or a heuristic function that estimates a lower bound cost of the optimal path from a current node to a goal node.

In some aspects, the method for optimizing delivery routes is implemented in a battery reverse logistics system where the payload weight includes a battery weight and the final destinations are determined based on proximity to recycling facilities.

Some aspects further comprise, in response to an expanded node producing a child node that is less optimal than a previously expanded node, pruning the child node from the search graph. Pruning may comprise removing one or more unexpanded nodes whose total estimated costs exceed an estimated cost of some previously expanded node.

In some aspects, the techniques described herein relate to a non-transitory computer-readable medium for storing instructions for executing a process, the instructions comprising: defining a cost function including a toll cost that is associated with both travel distance and payload weight; in response to receiving a starting location, a set of collection locations that each is associated with a payload weight and to be visited exactly once, and a set of final destinations, selecting an initial node comprising the starting location, which represents a state where no collection locations have been visited to initialize a search graph in which each node represents a state of a search space; in response to expanding the initial node by generating child nodes that each represents a visit to an unvisited collection location, updating the state; using the cost function to calculate, for each child node, a cost for the path between the initial node and the child node; computing a lower bound cost estimate for the optimal path between each child node and a goal node; obtaining an estimated total cost by adding together the lower bound cost estimate to a goal node and the path cost; selecting, among all nodes that have not been expanded, a node associated with a lowest estimated total cost, for node expansion; iterating expansion and cost computation steps until all collection locations in the set of collection locations have been visited; expanding nodes that have visited all collection locations by generating child nodes representing the set of final destinations; in response to a node selected for expansion being a goal node, using the goal node to define an optimal route from the starting location to a final destination, such that the optimal route visits all collection points only once; and using the optimal route to reduce the transportation cost.

Aspects of the present disclosure can involve a system, which can involve means for performing steps comprising defining a cost function comprising a toll cost that is associated with both travel distance and payload weight; means for performing steps comprising in response to receiving a starting location, a set of collection locations that each is associated with a payload weight and to be visited exactly once, and a set of final destinations, selecting an initial node comprising the starting location, which represents a state where no collection locations have been visited to initialize a search graph in which each node represents a state of a search space; means for performing steps comprising in response to expanding the initial node by generating child nodes that each represents a visit to an unvisited collection location, updating the state; means for performing steps comprising using the cost function to calculate, for each child node, a cost for the path between the initial node and the child node, means for computing a lower bound cost estimate for the optimal path between each child node and a goal node and obtaining an estimated total cost by adding together the lower bound cost estimate to a goal node and the path cost; means for performing steps comprising selecting, among all nodes that have not been expanded, a node associated with a lowest estimated total cost for a node expansion; means for performing steps comprising iterating expansion and cost computation steps until all collection locations in the set of collection locations have been visited; means for performing steps comprising expanding nodes that have visited all collection locations by generating child nodes representing the set of final destinations; means for performing steps comprising in response to a node selected for expansion being a goal node, using the goal node to define an optimal route from the starting location to a final destination, such the optimal route visits all collection points only once; and means for performing steps comprising using the optimal route to reduce the transportation cost.

### BRIEF DESCRIPTION OF DRAWINGS

FIG. 1 illustrates an exemplary routing optimization problem for collecting items with weights from two collection sites, where weights are depicted as vertical bars next to a collection site and squares are used to represent final destinations according to various embodiments of the present disclosure.

FIG. 2 illustrates the computational burden involved when using traditional state-of-the-art algorithms for solving the Shortest Hamiltonian Path Problem (SHPP).

FIG. 3 illustrates a comparison between a common SHPP routing problem that does not consider weights and a routing problem that considers weights according to various embodiments of the present disclosure, which generalizes the SHPP routing problem.

FIG. 4A and FIG. 4B illustrate search spaces using a layered tree structure according to various embodiments of the present disclosure.

FIG. 5A is a plot that compares an exemplary heuristic-search-based algorithm according to various embodiments of the present disclosure to a state-of-the-art Bellman-Held-Karp-based algorithm and a naïve algorithm.

FIG. 5B illustrates an example with three collection sites, according to various embodiments of the present disclosure.

FIG. 6 depicts an overview of the A* heuristic-based graph search algorithm.

FIG. 7A is a high-level flowchart of the A* algorithm.

FIG. 7B is a flowchart illustrating node expansion in A*.

FIG. 8 is a plot illustrating the non-linear speedup factor over the Bellman-Held-Karp algorithm as a function the number of nodes in a graph.

FIG. 9 is a flowchart illustrating an exemplary heuristic-based graph search process for optimizing delivery routes to minimize transportation cost of heavy objects in accordance with various embodiments of the present disclosure.

FIG. 10 illustrates an example computing environment with an example computer device, according to various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

Any headings used herein are for organizational purposes only and shall not be used to scope of the descriptions of the claims.

### General Introduction

According to the simplest cost model for transportation cost—a linear function of the total distance traveled—and without loss of generality, the objective function is total distance traveled. The problem can be formalized as the classical Travelling Salesman Problem (TSP), i.e., “Given a list of n locations and the distances between each pair of locations, what is the shortest possible route that visits each location exactly once and returns to the origin?” A closely related problem is the SHPP which, like the TSP, seeks the shortest route that visits each city exactly once but does not require a return to the origin. In the art, both problems are known to be NP-hard with respect to the number of to-be-visited locations. A state-of-the-art solution for SHPP is the Bellman-Held-Karp algorithm, a dynamic-programming algorithm that guarantees finding the shortest route in time (n²2ⁿ). It solves the optimization problem where costs are only a function of the distance travelled and no other costs, such as weight, are considered. In contrast, embodiments herein generalize SHPP by introducing weights to nodes in a search graph, such that both edge weight (i.e., distance between nodes) and node weight are considered in the to-be-minimized path cost.

As is known in the art, the A* graph search algorithm finds the shortest path in a graph that represents a state-space, as long as the heuristic function used to estimate the cost of the cheapest path from any node to a goal node never over-estimates the actual cost. A heuristic function is problem-specific and is mainly used to guide the search: the closer the cost estimate is to the actual cost, the better time complexity the A* algorithm can achieve. In extreme cases where the cost estimate equals the actual cost, A* will find the shortest path in linear time. The A* algorithm can thus be viewed as a graph search framework that guarantees finding the optimal solution; however, it does not prescribe how to represent the state-space or use any specific heuristic function to guide the search. A major challenge in using A* is to leverage domain-specific characteristics of the search space to design a good heuristic function, i.e., one that provides cost estimates that are lower-bound of actual costs but as close to them as possible. It is noted that while absent a suitable heuristic function, zero could be used as a cost lower bound. However, the resulting computational runtime would be too great and, thus rendering the application of A* useless for all practical purposes.

It is noted that although the heuristic-search-based systems and methods herein are generally described in the context of delivery route and routing cost optimizations, it is understood that this is not intended to limit the scope of the present disclosure to such embodiments as the systems and methods described herein may be easily adapted to solve a variety of problems, such as, for example, minimizing transportation costs when using weight-based toll roads to move goods or combining auto parts delivery with spent batteries reverse logistics, and may be extended to other objective functions.

### Overview of the Problem to be Solved

The transportation cost model, where the cost of moving a payload W over some distance D between two locations is proportional to not only the distance travelled D but also the product of the distance D and the payload weight W, can be expressed by the following equation:

$$cost ( W , D ) = D + WD \qquad Eq . ( 1 )$$

In this model, when transporting a payload over some distance, the cost attributed to weight is proportional to the payload weight. This reflects the fact that more energy is needed to transport heavier objects. The first term in Eq. (1) represents a weight-independent cost, whereas the second term represents a weight-dependent cost. In battery reverse logistics, transportation providers typically charge a price α per mile travelled as well as a price β per ton-mile, such that

$$cost ( W , D ) = α D + β WD \qquad Eq . ( 2 )$$

Without loss of generality, constants α and β can be dropped from the cost formula Eq. (2) since they can be absorbed into D and W.

Given a trip starting location at 0, battery collection locations i=1, . . . , N, battery weights wᵢ, and M final locations to which the batteries are to be transported, e.g., to be recycled, the goal is to find a route starting from location 0 that visits each of the N collection points, i.e., battery locations, exactly once, and end the route at one of the M final locations, while minimizing the transportation cost.

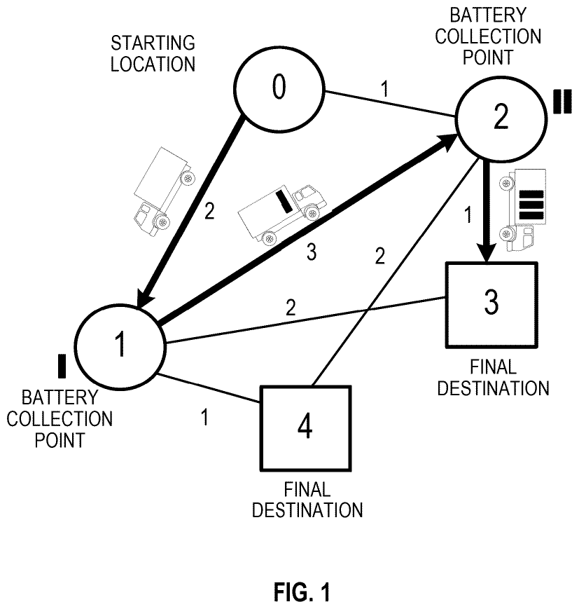

FIG. 1 illustrates an exemplary routing optimization problem for collecting items with weights from two collection sites, according to various embodiments of the present disclosure. Distances between locations are labeled numerically. For example, the distance between location #1 and location #2 is 3. In the example in FIG. 1, starting from location #0, all battery locations (here #1 and #2) are to be visited to collect batteries. Relative battery weights are depicted as vertical bars, i.e., location #1 has battery weight of 1 and location #2 has battery weight of 2. After collecting all batteries, having a total battery weight of 3, travel ends at one of the final destinations #3 or #4. As depicted, there are only four possible routes to consider: 0123, 0124, 0213, 0214, and the lowest cost route, having a total cost of 12=2+3+1+0×2+1×3+3×1, is route 0123.

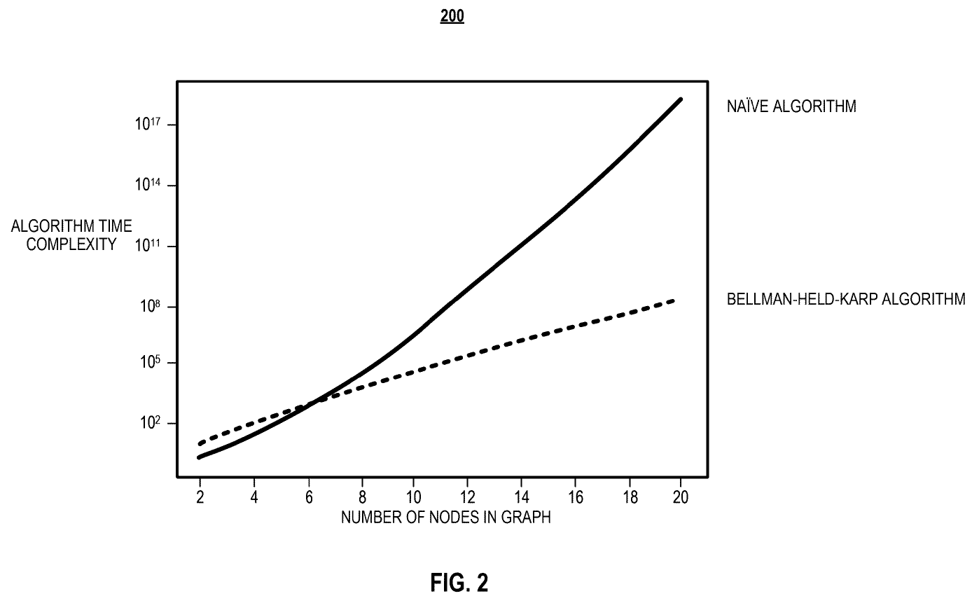

FIG. 2 illustrates the computational burden involved when using a traditional algorithm for solving SHPP. In general, given N collection points represented in a graph, even without considering weight, the problem is an instance of SHPP and, therefore, NP-Hard, i.e., worse than NP-Complete. A naive method consists of (1) enumerating all possible sequences of collection points and (2) evaluating the costs of each sequence. As a person of skill in the art will appreciate, this quickly becomes impractical for large values of N. As illustrated in plot 200, which uses a log scale for the Y-axis, for N=20, the naïve algorithm's complexity exceeds 10¹⁷, while the state-of-the-art Bellman-Held-Karp algorithm's complexity exceeds 10⁸, even though it solves only a special case that does not consider weights.

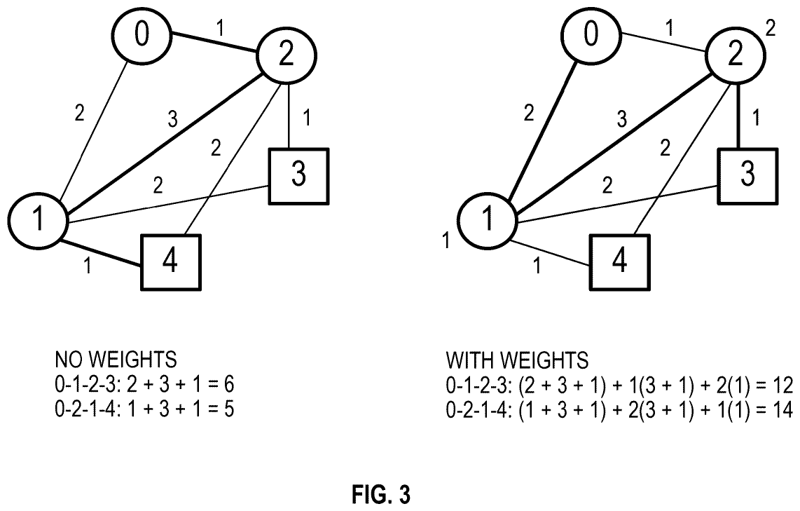

FIG. 3 illustrates a comparison between a common SHPP routing problem that does not consider weights and a routing problem that considers weights according to various embodiments of the present disclosure, which generalizes the SHPP routing problem. As depicted, the problem on the left, an instance of the SHPP problem, considers no weights, whereas the problem on the right, an instance of a generalized SHPP problem, does consider weights at each collection location. As can be seen, the optimal route depends on whether weights are considered in the optimization problem. Intuitively, when moving heavy items, the best strategy, all else being equal, is to collect lighter items first to be able to travel a greater distance.

Systems and methods herein formulate a route optimization problem as a heuristic graph search problem. Various embodiments use the previously mentioned A* framework and (1) structure the search space and represent the state of a node in the search graph; (2) expand a node into child nodes; (3) and define a heuristic function used to guide the search efficiently to ensure that the optimal route is found.

### Choice of Search Space Structure and State Representation Search Nodes

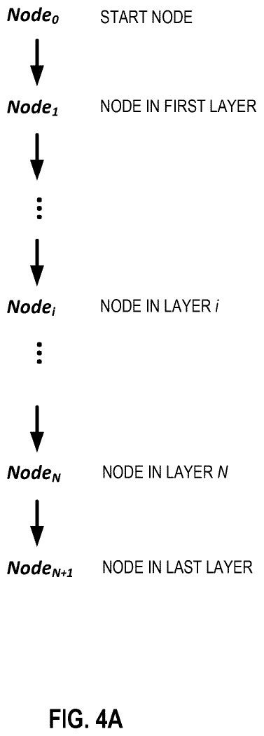

FIG. 4A illustrates a search space that is organized using a layered tree structure according to various embodiments of the present disclosure. The search nodes in the tree structure may represent various state. For example, a start node, denoted as Node₀, may represent the initial state at an initial location. In a first layer, a node denoted as Node₁ may represent a state where one location from a set of N battery locations has been visited. Nodeᵢ in layer i may represent a state where i locations from the set of N battery locations have been visited. Node_{N} in layer N may represent a state where all N battery locations have been visited. Finally, Node_{N+1} in the last layer, layer N+1, may represent a state where all N battery locations have been visited and the search has reached one of the M final destinations.

As shown in Table 1, each node Node in the search graph represents a state in a search space and may be described using the following specific attributes:

TABLE 1
Node

| | |
|---|---|
| Path | Sequence of locations visited, last item in |
| | sequence is the current location. |
| CumWeight | Sum of all the weights at the locations visited. |
| | Each location, except the initial location and |
| | the final locations, has a weight. |
| PathCost | Sum of all the un-weighted distances travelled |
| | on Path, plus the sum of all the weighted |
| | distances travelled. |

It is noted that the PathCost(Node) is additive. Moreover, if Node is a goal node (i.e., the last layer in search graph), then PathCost(Node) is the cost of a complete route that is to be minimized.

### Node Expansion Method

In the A* algorithm, a search proceeds by selecting a node that is not a goal node to “expand” it such as to produce a collection of child nodes. In embodiments herein, a node Nodet where i<N is expanded in the search space by choosing a collection location that has not been visited, producing the child node Nodeᵢ₊₁, as shown in Table 2 below, which illustrates updating of node contents when expanding a node that has not visited all pickup locations.

TABLE 2
Nodeᵢ₊₁

| | |
|---|---|
| Path | Append the new battery location to Path(Nodeᵢ). |
| | This new location is the current location |
| | for Nodeᵢ₊₁. |
| CumWeight | Add to CumWeight(Nodeᵢ) the weight at the |
| | current location. |
| PathCost | Add to PathCost(Nodeᵢ) the un-weighted distance |
| | between the current location and Nodeᵢ's location |
| | plus this distance weighted by CumWeight(Nodeᵢ). |

A node Node_{N}, where all collection locations have already been visited, may be expanded using one of the M final locations, producing the goal node Node_{N+1}, as shown in Table 3, which illustrates updating node contents when expanding a node that has visited all collection locations.

TABLE 3
Node_{N+1}

| | |
|---|---|
| Path | Append the selected final location to Path(Node_{N}). |
| | If this node is ever chosen for expansion, then |
| | Path is the solution route with minimal cost we |
| | are looking for. |
| CumWeight | Not needed for a goal node and therefore not defined. |
| PathCost | Add to PathCost(Node_{N}) the un-weighted distance |
| | between the current final location and Node_{N}'s |
| | location plus this distance weighted by |
| | CumWeight(Node_{N}). |

### Optimized Heuristic Function

As previously indicated, the A* algorithm is only a framework that does not prescribe how to structure the search space or what information needs to be represented in a state and which heuristic function to use, as these aspects are problem-specific. A special heuristic function, according to various embodiments herein is tailored to the route optimization problem, which estimates the cost of the optimal path to the goal node that is a lower bound and as close to the actual cost as possible. By leveraging the A* framework, the systems and methods herein are extended to accommodate any cost model, as long as an appropriate heuristic functions can be found.

Specifications for an optimized heuristic function specific to solving the problem using A* may comprise the following steps:
For i<N, let H be the subgraph for all remaining locations.
Let lb_{A}=Min(d_{A}) be the smallest distance between the current location and any remaining location, i.e., any location in H.
Let lb_{C}=Min(d_{C}) be the smallest distance between any remaining location and any final location.
Let lb_{E} be the sum of (N−i−1) smallest distances in H.
Let lb_{F} be the sum of (N−i−1) smallest distances in H, plus the sum of (N−i−2) smallest distances in H, . . . , plus the smallest distance in H.
Let lb_{W} be the smallest weight among the remaining locations (locations in H).

We seek a heuristic function that is as close to the optimal path cost to a goal node as possible. Here is an improved design with a tighter lower bound:

For any Nodeᵢ where i<N, we define our heuristic function as follows:

$$\hat{h} ( {Node}_{i} ) = ( CumWeight ( {Node}_{i} ) + 1 ) ( {lb}_{A} + {lb}_{C} + {lb}_{E} ) + {lb}_{W} [ ( N - i ) {lb}_{C} + {lb}_{F} )$$

Let lb_{D} be the smallest distance between Node_{N} and any final location, the heuristic function can be defined as follows:

$$\hat{h} ( {Node}_{N} ) = ( CumWeight ( {Node}_{N} ) + 1 ) ( {lb}_{D} )$$

This heuristic function ĥ(Nodeᵢ) can be computed efficiently, and since it is a lower bound to the optimal path cost to a goal node, the A*-based optimization process using this heuristic function is guaranteed to find a route with the lowest path cost.

### Experimental Data

It is noted that experimental data and results are provided by way of illustration and were performed under specific conditions using a specific embodiment or embodiments; accordingly, neither the experimental data nor their results shall be used to limit the scope of the present disclosure.

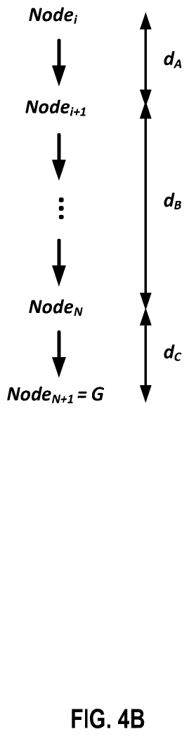

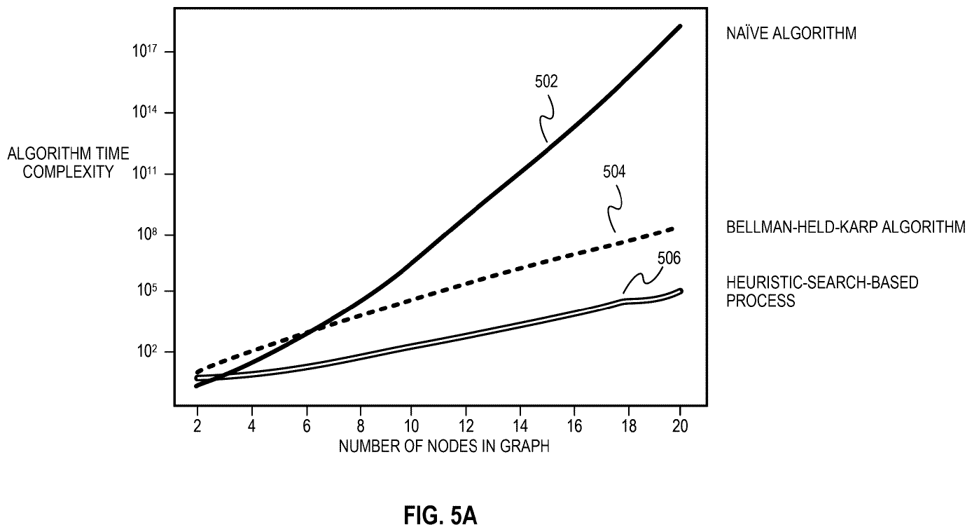

FIG. 5 is a plot that compares an exemplary heuristic-search-based algorithm according to various embodiments of the present disclosure to a Bellman-Held-Karp-based algorithm and a naïve algorithm. Empirically, up to N=20, the heuristic-search-based algorithm 506 is more efficient than both Bellman-Held-Karp-based algorithm 504 and naïve algorithm 502. Furthermore, the data shows that the gap in computational burden between the methods widens for higher values of N.

Table 4 uses the example in FIG. 1 to illustrate how A* uses the computations of the optimized heuristic function according to various embodiments to control a search and to quickly find the optimal route. As shown, Table 4 traces the process for a simple 2-node problem to illustrate how the optimized heuristic function is computed and used in A*. In this example, the number of collection sites N is 2.

TABLE 4

| | | | | | | | | | | | | | | | | Node with |
|---|---|---|---|---|---|---|---|---|---|---|---|---|---|---|---|---|
| | | | | | | | Path | | | | | | | | | smallest |
| | | Layer | | Subgraph | | Cum | Cost | | | | | | | | | g + h to |
| Iteration | Node | i | N − i − 1 | H | Path | Weight | g | IbA | IbC | IbD | IbE | IbW | IbF | ĥ | g + ĥ | Expand |
| 0 | 0 | 0 | 1 | {1, 2} | [0] | 0 | 0 | 1 | 1 | — | 3 | 1 | 3 | 10 | 10 | * |
| 1 | 1 | 1 | 0 | {2} | [0, 1] | 1 | 2 | 3 | 1 | — | 0 | 2 | 0 | 10 | 12 | * |
| | 2 | 1 | 0 | {1} | [0, 2] | 2 | 1 | 3 | 1 | — | 0 | 1 | 0 | 13 | 14 | — |
| 2 | 2 | 1 | 0 | {1} | [0, 2] | 2 | 1 | 3 | 1 | — | 0 | 1 | 0 | 13 | 14 | — |
| | 3 | 2 | — | { } | [0, 1, 2] | 3 | 8 | — | — | 1 | — | — | — | 4 | 12 | * |
| 3 | 2 | 1 | 0 | {1} | [0, 2] | 2 | 1 | 3 | 1 | — | 0 | 1 | 0 | 13 | 14 | — |
| | 4 | 3 | — | — | [0, 1, 2, 3] | — | 12 | — | — | — | — | — | — | 0 | 12 | * |
| | 5 | 3 | — | — | [0, 1, 2, 4] | — | 16 | — | — | — | — | — | — | 0 | 16 | — |

At each iteration, there exists a set of open nodes from which a node to expand and having the smallest (g+ĥ) value is chosen. This choice is indicated with an asterisk (*) in the last column in Table 4. Cells denoted with a hyphen (-) indicate values that are not needed and, thus, undefined.

At iteration 0, there is only one open node, node #0, thus node #0 is expanded, which results in node #1 and node #2. At iteration 1, node #1 is chosen to expand as it has the smallest (g+ĥ) value of 12. Node #1 expands into only 1 child node, node #3. At iteration 2, node #3 is expanded into two nodes, node #4 and node #5, which are both goal (i.e., last layer) nodes. At iteration 3, node #4 has the smallest (g+ĥ) value of 12, thus it is chosen for expansion, and since it is a goal node, A* stops. The optimal route is highlighted in bold text.

Table 5 shows another example that traces how A* uses an optimized heuristic function according to various embodiments is computed and used in A* to find the optimal route. In this example, depicted in FIG. 5B, A* searches the optimal route using heuristics with a slightly larger example where the number of collection sites N is 3.

TABLE 5

| | | | | | | | | | | | | | | | | Node with |
|---|---|---|---|---|---|---|---|---|---|---|---|---|---|---|---|---|
| | | | | | | | Path | | | | | | | | | smallest |
| | | Layer | | Subgraph | | Cum | Cost | | | | | | | | | g + h to |
| Iteration | Node | i | N − i − 1 | H | Path | Weight | g | IbA | IbC | IbD | IbE | IbW | IbF | ĥ | g + ĥ | Expand |
| 0 | 0 | 0 | 2 | {1, 2, 3} | [0] | 0 | 0 | 1 | 2 | — | 7 | 2 | 10 | 42 | 42 | * |
| 1 | 1 | 1 | 1 | {2, 3} | [0, 1] | 2 | 2 | 3 | 2 | — | 4 | 4 | 4 | 59 | 61 | * |
| | 2 | 1 | 1 | {1, 3} | [0, 2] | 6 | 1 | 3 | 3 | — | 4 | 2 | 4 | 90 | 91 | — |
| | 3 | 1 | 1 | {1, 2} | [0, 3] | 4 | 3 | 4 | 2 | — | 3 | 2 | 3 | 59 | 62 | — |
| 2 | 2 | 1 | 1 | {1, 3} | [0, 2] | 6 | 1 | 3 | 3 | — | 4 | 2 | 4 | 90 | 91 | — |
| | 3 | 1 | 1 | {1, 2} | [0, 3] | 4 | 3 | 4 | 2 | — | 3 | 2 | 3 | 59 | 62 | * |
| | 4 | 2 | 0 | {3} | [0, 1, 2] | 8 | 11 | 4 | 3 | — | 0 | 4 | 0 | 75 | 86 | — |
| | 5 | 2 | 0 | {2} | [0, 1, 3] | 6 | 14 | 4 | 2 | — | 0 | 6 | 0 | 54 | 68 | — |
| 3 | 2 | 1 | 1 | {1, 3} | [0, 2] | 6 | 1 | 3 | 3 | — | 4 | 2 | 4 | 90 | 91 | — |
| | 4 | 2 | 0 | {3} | [0, 1, 2] | 8 | 11 | 4 | 3 | — | 0 | 4 | 0 | 75 | 86 | — |
| | 5 | 2 | 0 | {2} | [0, 1, 3] | 6 | 14 | 4 | 2 | — | 0 | 6 | 0 | 54 | 68 | * |
| | 6 | 2 | 0 | {2} | [0, 3, 1] | 6 | 23 | 3 | 2 | — | 0 | 6 | 0 | 47 | 70 | — |
| | 7 | 2 | 0 | {1} | [0, 3, 2] | 10 | 23 | 3 | 5 | — | 0 | 2 | 0 | 98 | 121 | — |
| 4 | 2 | 1 | 1 | {1, 3} | [0, 2] | 6 | 1 | 3 | 3 | — | 4 | 2 | 4 | 90 | 91 | — |
| | 4 | 2 | 0 | {3} | [0, 1, 2] | 8 | 11 | 4 | 3 | — | 0 | 4 | 0 | 75 | 86 | — |
| | 6 | 2 | 0 | {2} | [0, 3, 1] | 6 | 23 | 3 | 2 | — | 0 | 6 | 0 | 47 | 70 | — |
| | 7 | 2 | 0 | {1} | [0, 3, 2] | 10 | 23 | 3 | 5 | — | 0 | 2 | 0 | 98 | 121 | — |
| | 8 | 3 | — | { } | [0, 1, 3, 2] | 12 | 42 | — | — | 2 | — | — | — | 26 | 68 | * |
| 5 | 2 | 1 | 1 | {1, 3} | [0, 2] | 6 | 1 | 3 | 3 | | 4 | 2 | 4 | 90 | 91 | |
| | 4 | 2 | 0 | {3} | [0, 1, 2] | 8 | 11 | 4 | 3 | | 0 | 4 | 0 | 75 | 86 | |
| | 6 | 2 | 0 | {2} | [0, 3, 1] | 6 | 23 | 3 | 2 | | 0 | 6 | 0 | 47 | 70 | |
| | 7 | 2 | 0 | {1} | [0, 3, 2] | 10 | 23 | 3 | 5 | | 0 | 2 | 0 | 98 | 121 | |
| | 9 | 4 | — | — | [0, 1, 3, 2, 4] | — | 68 | — | — | — | — | — | — | 0 | 68 | * |

As depicted, in Table 5, at iteration 5, open node #9 has the smallest (g+ĥ) value of 68, so it is chosen for expansion, and since it is a goal node, A* finds the optimal solution and stops. The optimal route is indicated in bold text.

To understand how the problem is formulated as a heuristic-search problem using A*, a brief technical background of the A* algorithm is provided.

### Technical Background of the A* Algorithm

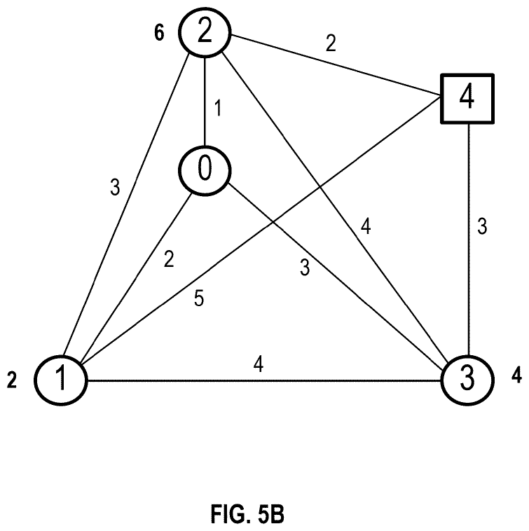

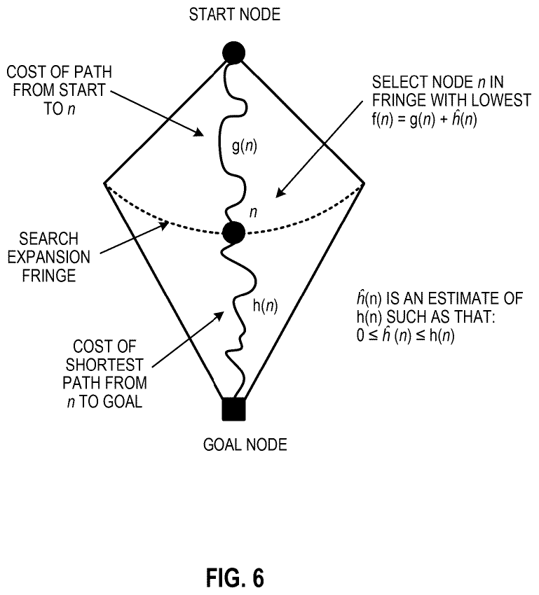

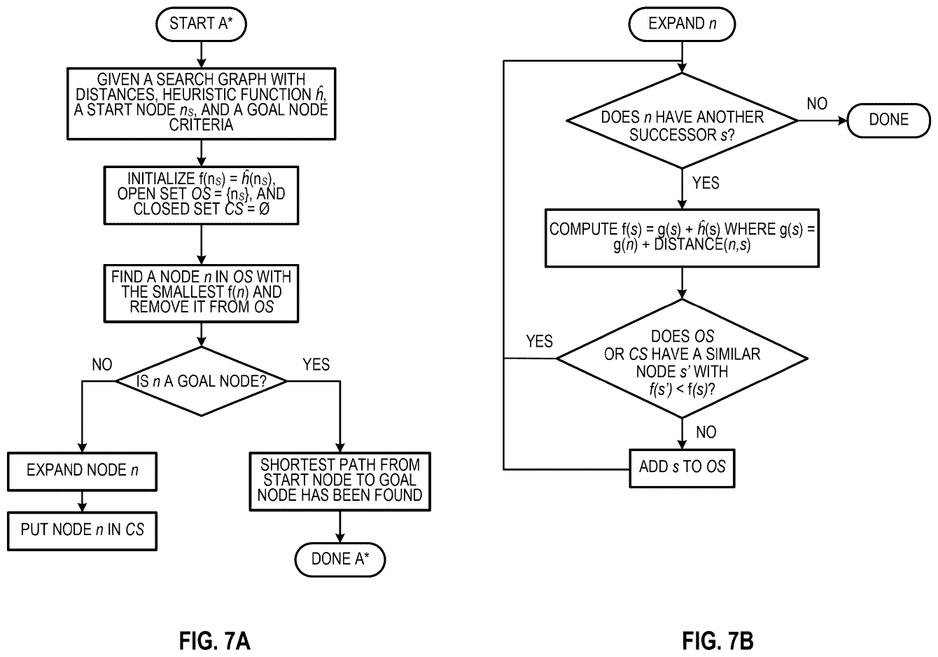

The diagram in FIG. 6 provides an overview of the A* algorithm, a best-first graph search algorithm that searches for the lowest cost path from a start node to a goal node in a possibly directed graph, uses a heuristic function to search for the lowest cost path. Since the exact cost h of the optimal path from a node to the goal node is generally not available, A* uses an estimate ĥ, called heuristic function. If the heuristic function never over-estimate the true optimal cost, A* is always guaranteed to find the optimal path. FIG. 7A is a high-level flowchart of the A* algorithm, and FIG. 7B is a flowchart that illustrates node expansion in A*.

### Developing a Good Heuristic Function

First, an initial design of a heuristic function according to various embodiments of the present disclosure is presented by finding a lower bound for the true path cost h(Nodeᵢ) from a current node Nodeᵢ to a goal node Node_{N+1}.

Assuming the path shown in FIG. 4B is the lowest-cost path, the following equations show the true path cost from Nodeᵢ to the goal node G, when i<N, where the first term is the cost of moving CumWeight(Nodeᵢ) to the goal node G, and the second term is the cost of moving the weights at each of the remaining nodes to G:

$$h ( {Node}_{i} ) = ( 1 + CumWeight ( {Node}_{i} ) ] ( {d}_{A} + {d}_{B} + {d}_{C} ) + {\sum }_{i + 1 \leq j \leq N} Weight ( {Node}_{j} ) {\sum }_{j \leq k \leq N} Dist ( {Node}_{k} , {Node}_{k + 1} )$$

$$First , {d}_{A} \geq {lb}_{A} = {Min}_{i + 1 \leq j \leq N} Dist ( {Node}_{i} , {Node}_{j} )$$

$$Second , {d}_{B} \geq {lb}_{B} = ( N - i - 1 ) {lb}_{R} where :$$

$${lb}_{R} = Min Dist ( H ) = {Min}_{i + 1 \leq j < k \leq N} Dist ( {Node}_{j} , {Node}_{k} )$$

$$Third , {d}_{C} \geq {lb}_{C} = {Min}_{i + 1 \leq j \leq N} Dist ( {Node}_{j} , {Node}_{N + 1} )$$

Let lb_{W}=Min_{i+1≤j≤N}Weight(Nodeⱼ), then it is not difficult to verify the following, where we bound the total length of all path suffixes using 0.5 (N−i)(N−i−1) lb_{R}:

$$h ( {Node}_{i} ) = [ 1 + CumWeight ( {Node}_{i} ) ] ( {lb}_{A} + {lb}_{B} + {lb}_{C} ) + {lb}_{W} ( N - i ) ( 0.5 {lb}_{B} + {lb}_{C} )$$

For i<N, the initial heuristic function is:

$$\hat{h} ( {Node}_{i} ) = ( 1 + CumWeight ( {Node}_{i} ) ] ( {lb}_{A} + {lb}_{B} + {lb}_{C} ) + {lb}_{W} ( N - i ) ( 0.5 {lb}_{B} + {lb}_{C} )$$

For i=N, let lb_{D}=Min_{G}Dist(Node_{N}, G). Then, the initial heuristic function is:

$$\hat{h} ( {Node}_{N} ) = [ 1 + CumWeight ( {Node}_{N} ) ] ( {lb}_{D} )$$

In embodiments, the initial heuristic function may be further improved by tightening some of the lower bounds that are used:

First, for d_{B}, (N−i−1) times the smallest distance lb_{R} is used in subgraph H as a rough lower bound for the length of any Hamiltonian path through H. To refine this lower bound, lb_{E}, defined as the sum of the (N−i−1) smallest distances in H, where clearly d_{B}≥lb_{B}≥lb_{B}, may be used.

Previously, to lower-bound the total length of all path suffixes from Nodeᵢ₊₁ to Node_{N} in H, 0.5 (N−i)(N−i−1)lb_{R} was used. To refine this lower bound, lb_{R}, defined as be the sum of (N−i−1) smallest distances in H, plus the sum of (N−i−2) smallest distances in H, . . . , plus the smallest distance in H may be used.

In summary, for i<N, a better heuristic function is:

$$\hat{h} ( {Node}_{i} ) = [ 1 + CumWeight ( {Node}_{i} ) ] ( {lb}_{A} + {lb}_{B} + {lb}_{C} ) + {lb}_{W} ( {lb}_{F} + ( N - i ) {lb}_{C} )$$

### Strategies for Pruning the Search Space

In the A* framework, node-pruning is based on node similarity which depends on how the search state is represented in a node. In embodiments herein, as part of a node representation, Path(Node), defined as the sequence of locations visited from the start node to the current node, may be used. For the purpose of pruning search space, Node and Node′ are defined as similar when: (1) Path(Node) and Path(Node′) have the same last location; and (2) Path(Node) and Path(Node′) have the same location set excluding the last location. In other words, the order in which the locations are visited before getting to the current location should be ignored in determining whether the two nodes are similar.

For efficiency, sets of location may be represented in implementation as bitmaps for fast comparisons.

### Details of the Performance Comparison Benchmark

For SHPP with a N-node graph, the time complexity values used in the benchmark are as follows:
(1) Naïve (brute force) algorithm: N! (number of permutations).
(2) Bellman-Held-Karp algorithm: N²2^{N}
(3) Even if not available in closed form, various embodiments that are based on an A* heuristic search algorithm may be determined empirically by using the number of nodes expanded by A*. For each value of N up 20, embodiments use a complete graph with randomly generated distances between nodes and collect the number of nodes expanded. Iterating 1000/N times, statistics such as the mean number of nodes expanded may be computed.

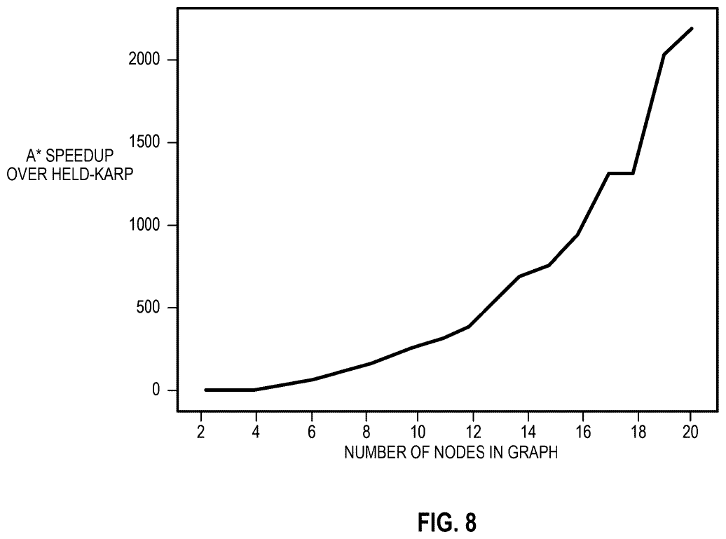

As previously mentioned, the time complexity gap between the Bellman-Held-Karp algorithm and the heuristic-search-based algorithm according to various embodiments, widens for higher values of N. FIG. 8 is a plot that illustrates the speedup factor over the Bellman-Held-Karp process as a function the number of nodes in a graph.

Overall, embodiments herein help optimize transportation costs when to-be-collected batteries are distributed across scattered locations as transportation costs dominate end-of-life battery reverse logistics. These costs are a function of distance travelled and weight of payload. Both the locations where batteries are collected and their weights can change dynamically. Even though the distance between locations is immutable, the optimization cannot be solved in advance and must be repeated for new situations. Therefore, efficiency is important, especially since the problem is NP-hard. The quality of the heuristic function used herein is critical for an efficient search for the optimal route. In turn, a more efficient search allows for larger numbers of battery collection locations. The heuristic-search-based methods herein may be implemented as part of a battery reverse logistics system. Such systems fully leverage and are enabled by the computational efficiency and solution scalability afforded by the systems and method presented herein.

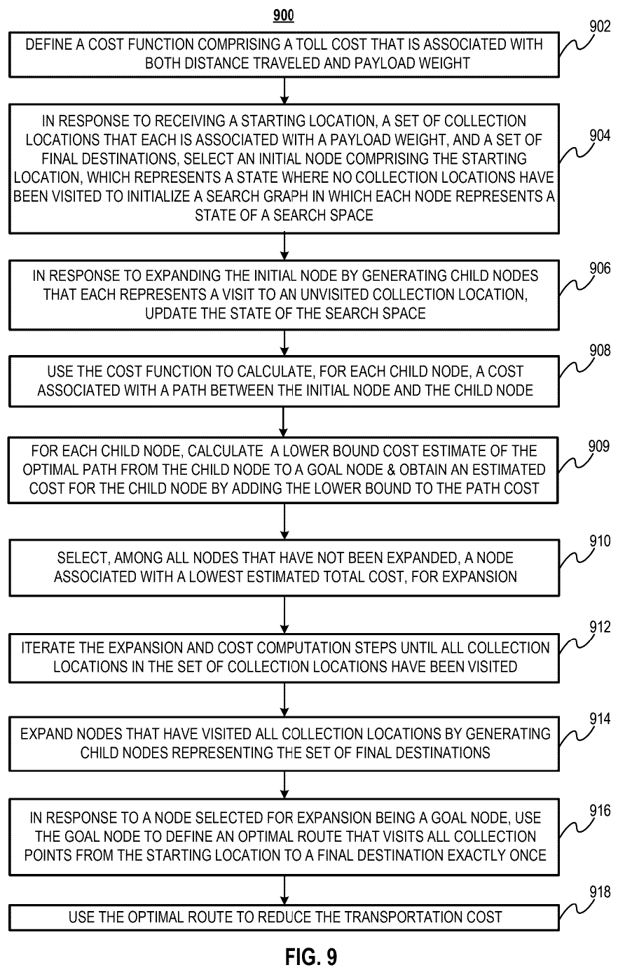

FIG. 9 is a flowchart illustrating an exemplary heuristic-based graph search process for optimizing delivery routes to reduce transportation cost of heavy objects in accordance with various embodiments of the present disclosure.

In embodiments, process 900 may start at step 902, when a cost function comprising a toll cost, which is associated with both distance traveled and payload weight, is defined.

At step 904, in response to receiving a starting location, a set of collection locations that each is associated with a payload weight, and a set of final destinations, an initial node, which comprises the starting location that represents a state where no collection locations have been visited, is selected to initialize a search graph in which each node represents a state of a search space.

At step 906, in response to expanding the initial node by generating child nodes that each represents a visit to an unvisited collection location, the state of a search space is updated.

At step 908, the cost function is used to calculate, for each child node, a cost for a path between the initial node and the child node.

At step 908, for each child node, a lower bound estimate of the optimal path cost between the child node and a total node is calculated. The estimated total cost is obtained by adding this lower bound cost estimate to the path cost.

At step 910, a node associated with a lowest estimated total cost is selected among all nodes that have not been expanded, for expansion.

At step 912, expansion and cost computation steps are iterated until all collection locations in the set of collection locations have been visited.

At step 914, nodes that have visited all collection locations are expanded by generating child nodes representing the set of final destination locations.

At step 916, in response to a node selected for expansion being a goal node, the goal node is used to define an optimal route that visits all collection points from the starting location to a final destination exactly once.

Finally, at step 918, the optimal route is used to reduce a transportation cost, e.g., by visualizing the optimal route on a digital map interface.

One skilled in the art shall recognize that: (1) certain steps may optionally be performed; (2) steps may not be limited to the specific order set forth herein; (3) certain steps may be performed in different orders; and (4) certain steps may be done concurrently.

It is noted that although the invention is generally described in the context of EV battery reverse logistics solutions, it is understood that this is not intended to limit the scope of the present disclosure as the teachings described herein may be used in any type of logistics system or related applications.

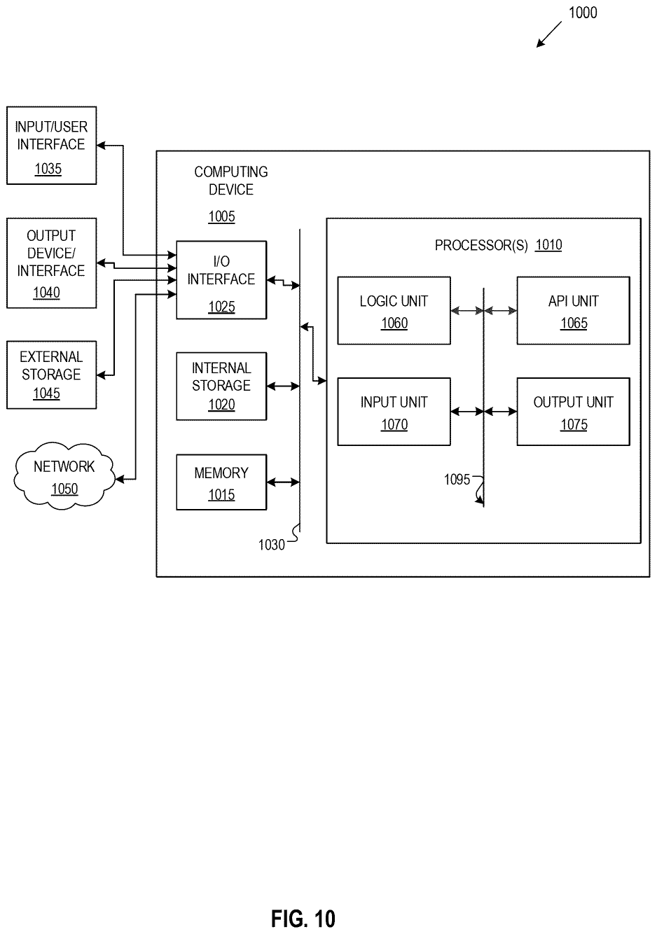

FIG. 10 illustrates an example computing environment with an example computer device suitable for use in some example implementations. Computer device 1005 in computing environment 1000 can include one or more processing units, cores, or processors 1010, memory 1015 (e.g., RAM, ROM, and/or the like), internal storage 1020 (e.g., magnetic, optical, solid-state storage, and/or organic), and/or I/O interface 1025, any of which can be coupled on a communication mechanism or bus 1030 for communicating information or embedded in the computer device 1005. I/O interface 1025 is also configured to receive images from cameras or provide images to projectors or displays, depending on the desired implementation.

Computer device 1005 can be communicatively coupled to input/user interface 1035 and output device/interface 1040. Either one or both of input/user interface 1035 and output device/interface 1040 can be a wired or wireless interface and can be detachable. Input/user interface 1035 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 1040 may include a display, television, monitor, printer, speaker, braille, or the like. In some example implementations, input/user interface 1035 and output device/interface 1040 can be embedded with or physically coupled to the computer device 1005. In other example implementations, other computer devices may function as or provide the functions of input/user interface 1035 and output device/interface 1040 for a computer device 1005.

Examples of computer device 1005 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 1005 can be communicatively coupled (e.g., via I/O interface 1025) to external storage 1045 and network 1050 for communicating with any number of networked components, devices, and systems, including one or more computer devices of the same or different configurations. Computer device 1005 or any connected computer device can be functioning as, providing services of, or referred to as a server, client, thin server, general machine, special-purpose machine, or another label.

I/O interface 1025 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, a satellite network, and the like).

Computer device 1005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 1005 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 1010 can execute under any operating system (OS) (not shown), in a native or virtual environment. One or more applications can be deployed that include logic unit 1060, application programming interface (API) unit 1065, input unit 1070, output unit 1075, and inter-unit communication mechanism 1095 for the different units to communicate with each other, with the OS, and with other applications (not shown). The described units and elements can be varied in design, function, configuration, or implementation and are not limited to the descriptions provided. Processor(s) 1010 can be in the form of hardware processors such as central processing units (CPUs) or a combination of hardware and software units.

In some example implementations, when information or an execution instruction is received by API unit 1065, it may be communicated to one or more other units (e.g., logic unit 1060, input unit 1070, output unit 1075). In some instances, logic unit 1060 may be configured to control the information flow among the units and direct the services provided by API unit 1065, input unit 1070, and output unit 1075, in some example implementations described above. For example, the flow of one or more processes or implementations may be controlled by logic unit 1060 alone or in conjunction with API unit 1065. The input unit 1070 may be configured to obtain input for the calculations described in the example implementations, and the output unit 1075 may be configured to provide output based on the calculations described in example implementations.

Processor(s) 1010 can be configured to execute a method or computer instructions which can involve, defining a cost function comprising a toll cost that is associated with both travel distance and payload weight; in response to receiving a starting location, a set of collection locations that each is associated with a payload weight, and a set of final destinations, selecting an initial node comprising the starting location, which represents a state where no collection locations have been visited to initialize a search graph in which each node represents a state of a search space; in response to expanding the initial node by generating child nodes that each represents a visit to an unvisited collection location, updating the state; using the cost function to calculate, for each child node, a cost for a path between the initial node and the child node; selecting, among all nodes that have not been expanded, a node associated with a lowest estimated total cost for node expansion; iterating expansion and cost computation steps until all collection locations in the set of collection locations have been visited; expanding nodes that have visited all collection locations by generating child nodes representing the set of final destinations; in response to a node selected for expansion being a goal node, using the goal node to define an optimal route from the starting location to a final destination, such that the optimal visits all collection points exactly once; and using the optimal route to reduce the transportation cost, as described, for example, with respect to FIG. 9 and FIG. 10.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for optimizing delivery routes to minimize transportation cost, the method comprising:
defining a cost function comprising a toll cost that is associated with both travel distance and payload weight;
in response to receiving a starting location, a set of collection locations that each is associated with a payload weight and to be visited exactly once, and a set of final destinations,
selecting an initial node comprising the starting location, which represents a state where no collection locations have been visited to initialize a search graph in which each node represents a state of a search space;
in response to expanding the initial node by generating child nodes that each represents a visit to an unvisited location, updating the state;
using the cost function to calculate, for each child node, a cost for the path between the initial node and the child node;
selecting, among all nodes that have not been expanded, a node associated with a lowest estimated total cost, as the next node to expand, wherein the total cost of a node is defined as the cost of the path from initial node to the node plus a lower bound estimate of the cost of the optimal path between the node and a goal node;
iterating expansion and cost computation steps until all collection locations in the set of collection locations have been visited;
expanding nodes that have visited all collection locations by generating child nodes representing the set of final destinations;
in response to a node selected for expansion being a goal node, using the goal node to define an optimal route from the starting location to a final destination, such that the optimal route visits all collection points only once; and
using the optimal route to reduce the transportation cost.

2. The method according to claim 1, wherein information represented in the state of the search space comprises a current path, which represents the sequence of locations visited, cumulative weight, which is the sum of all weights on the current path, and path cost, which is the toll costs on the current path accounting for both distance traveled and payload weights.

3. The method according to claim 1, further comprising the step of adjusting the node state after a node expansion.

4. The method according to claim 1, further comprising a heuristic function that estimates a lower bound cost of the optimal path from a current node to a goal node.

5. The method according to claim 1, wherein the method for optimizing delivery routes is implemented in a battery reverse logistics system and the payload weight comprises a battery weight.

6. The method according to claim 5, wherein the final destinations are determined based on proximity to recycling facilities.

7. The method according to claim 1, further comprising, in response to an expanded node producing a child node that is less optimal than a previously expanded node, pruning the child node from the search graph.

8. The method according to claim 7, wherein pruning comprises removing one or more unexpanded nodes whose estimated total costs exceed an estimated total cost of the previously expanded node.

9. A non-transitory computer-readable medium for storing instructions for executing a process, the instructions comprising:
defining a cost function comprising a toll cost that is associated with both travel distance and payload weight;
in response to receiving a starting location, a set of collection locations that each is associated with a payload weight and to be visited exactly once, and a set of final destinations, selecting an initial node comprising the starting location, which represents a state where no collection locations have been visited to initialize a search graph in which each node represents a state of a search space;
in response to expanding the initial node by generating child nodes that each represents a visit to an unvisited collection location, updating the state;
using the cost function to calculate, for each child node, a cost for a path between the initial node and the child node;
selecting, among all nodes that have not been expanded, a node associated with a lowest estimated total cost for a node expansion;
iterating expansion and cost computation steps until all collection locations in the set of collection locations have been visited;
expanding nodes that have visited all collection locations by generating child nodes representing the set of final destinations;
in response to a node selected for expansion being a goal node, using the goal node to define an optimal route from the starting location to a final destination, such that the optimal route visits all collection points only once; and
using the optimal route to reduce the transportation cost.

10. The non-transitory computer-readable medium of claim 9, wherein information represented in the state of the search space comprises a current path, cumulative weight, and path cost.

11. The non-transitory computer-readable medium of claim 9, wherein the instructions further comprise adjusting the cost function to include toll costs based on a vehicle weight.

12. The non-transitory computer-readable medium of claim 9, wherein the instructions further comprise a heuristic function that estimates a lower bound cost to reduce a search from a current node to a goal node.

13. The non-transitory computer-readable medium of claim 9, wherein the payload weight comprises a battery weight.

14. The non-transitory computer-readable medium of claim 13, wherein the final destinations are determined based on proximity to recycling facilities.

15. The non-transitory computer-readable medium of claim 9, wherein the instructions further comprise, in response to an expanded node producing a child node that is less optimal than a previously expanded node, pruning the child node from the search graph.

16. The non-transitory computer-readable medium of claim 15, wherein pruning comprises removing one or more unexpanded nodes whose total estimated costs exceed an estimated cost of the previously expanded node.

17. An apparatus comprising:
a processor, configured to:
define a cost function comprising a toll cost that is associated with both travel distance and payload weight;
in response to receiving a starting location, a set of collection locations that each is associated with a payload weight and to be visited exactly once, and a set of final destinations, select an initial node comprising the starting location, which represents a state where no collection locations have been visited to initialize a search graph in which each node represents a state of a search space;
in response to expanding the initial node by generating child nodes that each represents a visit to an unvisited collection location, update the state;
use the cost function to calculate, for each child node, a cost for a path between the initial node and the child node;
select, among all nodes that have not been expanded, a node associated with a lowest estimated total cost for a node expansion;
iterate expansion and cost computation steps until all collection locations in the set of collection locations have been visited;
expand nodes that have visited all collection locations by generating child nodes representing the set of final destinations;
in response to a node selected for expansion being a goal node, use the goal node to define an optimal route from the starting location to a final destination, such that the optimal route visits all collection points only once; and
using the optimal route to reduce the transportation cost.

18. The apparatus of claim 17, wherein information represented in the state of the search space comprises a current path, cumulative weight, and path cost.

19. The apparatus of claim 17, wherein the processor is further configured to use a heuristic function that estimates a lower bound cost to reduce a search from a current node to a goal node.

20. The apparatus of claim 17, wherein the processor is further configured to, in response to an expanded node producing a child node that is less optimal than a previously expanded node, prune the child node from the search graph by removing one or more unexpanded nodes whose total estimated costs exceed an estimated cost of the previously expanded node.
